(19) United States
(12) Patent Application Publication
(10) Pub. No.: US 2015/0115538 A1
(43) Pub. Date: Apr. 30, 2015

(54) SEAL ASSEMBLY FOR PUMPS AND FLUID MIXERS

(71) Applicant: Nunzio D'ORAZIO, Trevi (PG) (IT)

(72) Inventor: Nunzio D'ORAZIO, Trevi (PG) (IT)

(73) Assignee: MECCANOTECNICA UMBRA - S.P.A., Campello Sul Clitunno (PG) (IT)

(21) Appl. No.: 14/523,210

(22) Filed: Oct. 24, 2014

(30) Foreign Application Priority Data
Oct. 29, 2013 (IT) AN2013A000200

(51) Int. Cl. F16J 15/16

(52) U.S. Cl. CPC F16J 15/16
USPC 277/358

(57) ABSTRACT

An improved front mechanical seal assembly for pumps and fluid mixers, has an empty body that houses a pair of front mechanical seal rings surrounded by an annular chamber ending with an inlet channel obtained in the empty body, one or more channels for introduction of a washing liquid obtained in the empty body and ending into the annular chamber, a flange fixed to the empty body, housed inside the inlet channel and shaped in such manner to determine an overflow that favors the stagnation of the washing liquid in said annular chamber.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present patent application relates to an improved front mechanical seal assembly for pumps and fluid mixers, in particular for dirty fluids, adhesives, binding substances, multi-phase fluids and the like. More precisely, possible fields of application of the improved assembly of the invention are the tanks where concrete is prepared and the suction pumps of purification or industrial muds.

2. Description of Related Art Including Information Disclosed Under 37 CFR 1.97 and 37 CFR 1.98.

FIG. 1 shows a seal assembly (100), according to the prior art, applied to the tank of a mixer, such as the one disclosed in WO2010/012317. The seal assembly (100) is sectioned with a plane passing through the axis of rotation of the mixer shaft.

A known mixer comprises a tank containing the material to be mixed and one or two rotating shaft. FIG. 1 shows only one shaft (1) rotating in the tank. The mixer comprises a wall (P) and floodgate (P1) delimitating the tank extending to the left of the floodgate (P1).

The seal assembly (100) extends to the right of the wall (P). The seal assembly (100) comprises an empty body (2) adapted to be crossed by the shaft (1) of the mixer. The empty body (2) is provided with a flange (2a) for fixing the empty body outside the wall (P) of the mixer. In this manner, an annular inlet channel (3) is created between the empty body (2) and floodgate (P1) of the mixer, wherein the fluid processed inside the mixer tank is introduced.

The seal assembly (100) comprises two interfaced frictional seal rings (4, 5), which are adapted to create a mechanical front seal with respect to the fluid entering in the annular inlet channel (3).

The first ring (4) revolves, it being joined to the revolving shaft (1) by means of a first support collar (40) mounted outside a tube (40a) tightened around the shaft (1) by means of an elastic tightening ring (1a) and a collar ring (1b). In view of the above the first ring (4) revolves together with the shaft (1).

The second ring (5) is fixed, it being fixed to the empty body (2). More precisely, the second ring (5) is supported by a second support collar (50) that is slidingly coupled to the empty body (2) along a direction parallel to the axis of rotation of the shaft (1).

A plurality of springs (51) push the support collar (50) in a translation towards the first ring (4) in such manner to keep the interfaced frictional surfaces of the rings (4, 5) always in close contact. The springs (51) are disposed inside housings (50a) obtained in said second support collar (50) and closed by a counter flange (50b) secured to the empty body (2).

A gap (52) is obtained between the tube (40a) and the second support collar (50), since the tube (40a) revolves with the shaft (1) and the second support collar (50) is not rotating.

As clearly shown in FIG. 1, the inlet channel (3) of the processed fluid ends with a narrow annular chamber (30) that externally surround the pair of rings (4, 5).

The stagnation of the fluid processed by the mixer in the annular chamber (30) of the inlet channel (3) would cause several drawbacks in case of fluids that tend to adhere to the rings after thickening and solidification. For illustrative purposes only, the fluids that may favor the onset of said drawbacks are polymer-based fluids, multi-phase fluids, mixes of aggregated substances that tend to solidify (such as, for example, concrete during mixing or materials that tend to polymerize or thicken during handling and to change state), fluids having the consistency or nature of industrial or civil muds (in purification processes), dirty waste waters or waters composed of aggregates that are chemically difficult to characterize (water-soil mixes, muds, crushed stone mixed with mud, etc.).

In order to prevent the onset of said drawbacks, the seal assembly (100) is normally provided with a hydraulic system adapted to flow the annular chamber (30) with a washing liquid (L) that is also used to cool down and lubricate the rings (4, 5). The washing-cooling liquid (L) can be water, which is normally used in the applications of concrete mixing tanks or in pumps used to treat muds from civil or industrial purification installations, or oil in case of heavier operating conditions of the seal.

For this reason, at least one inlet radial channel (20) for the washing liquid (L) is obtained in the empty body (2) of the seal assembly (100), which ends in the annular chamber (30) that surrounds the rings (4, 5). The washing system avoids that, after crossing the inlet channel (3), the fluid flowing out from the mixer tank reaches and adheres externally to the rings or penetrates between the interfaced frictional surfaces of the rings, thus making them stick one to each other. In the most severe situations such an adhesion of the rings (4, 5) prevents the start of the shaft (1) used to move the fluid, thus impairing its operation.

Moreover, the fact that the fluid reaches the external walls of the seal rings or thickens and solidifies inside the annular chamber (30) reduces the thermal exchange coefficient on the surfaces of the rings of the mechanical seal. In such a situation, the power generated by friction between the two seal rings is not dissipated towards the fluid and increases the temperature of the seal rings, thus impairing the mechanical-structural behavior of the seal. In some situations the temperature increase of the revolving rings may be followed by the immediate immersion of the seal in the fluid that has restored its original nature, thus causing thermal shock situations.

Another drawback caused by the stagnation and consolidation of the fluid inside the annular chamber (30) consists in the attenuation, if not the elimination, of the action of the springs (51) adapted to push the fixed ring (5) against the revolving ring (4) with consequent loss of the mechanical seal effect between the pair of frictional rings (4, 5).

Another drawback is caused by accidental fluid leaks reaching a drain area of the losses (A) after axially passing through said annular gap (52) in the direction of the arrow (F1) indicated in FIG. 1. The annular gap (52) is internally defined by the uninterrupted surface of the tube (40a). The annular gap (52) is externally defined, in sequential order, by the cylindrical surface of the second support collar (50) and by the cylindrical surface of said counter flange (50b), with the presence of an opening (R) between said contiguous cylindrical surfaces, which is a passage and migration way for said fluid leaks towards the housings (50a) of said springs (51).

In order to avoid the aforementioned drawbacks, it is extremely important to prevent the unopposed free access of the fluid processed by the mixer or the pump provided with the seal assembly (100) of the invention into the annular chamber (30), favoring instead the flow and stagnation of the washing liquid (L) in the chamber.

The main purpose of the present invention is to improve the front mechanical seal assemblies for pumps and fluid mixers of the prior art, of the type described above, with the primary objective of favoring the filling and the stagnation of the washing liquid in the annular chamber that surrounds the pair of seal rings.

Another purpose of the present invention is to improve the front mechanical seal assemblies of the prior art, with the secondary objective of preventing any accidental fluid leaks through the interfaced frictional surfaces of the pair of seal rings from reaching the housings of the springs pushing the second seal ring, damaging the natural elasticity of the spring, with consequent loss of mechanical seal between the pair of seal frictional rings.

### BRIEF SUMMARY OF THE INVENTION

These purposes are achieved according to the present invention, with the characteristics claimed in the attached independent claim 1.

Advantageous embodiments appear from the dependent claims.

The improved seal assembly for pumps and fluid mixers according to the invention comprises:
an empty body adapted to be secured to a fixed chassis of a mixer or a pump,
a first frictional ring joined to the revolving shaft of said mixer or pump,
a second frictional ring coupled with said empty body in such manner to be in contact with said first frictional ring to generate a seal against the fluid processed by said mixer or pump,
an channel obtained in said empty body, in which the fluid processed by said mixer or pump is introduced, said channel ending with an annular chamber that surrounds the pair of seal rings.

The improved seal assembly of the invention also comprises a flange housed inside said inlet channel of the fluid processed by said mixer or pump and shaped in such manner to generate an overflow that favors the stagnation of the washing liquid inside the annular chamber that surrounds the pair of seal rings.

Therefore, even when the shaft of the mixer or the pump is still and the fluid filling the inlet channel tends to consolidate as a paste, the annular chamber holds an amount of washing liquid under the head, the level of which is determined by said overflow.

### BRIEF DESCRIPTION OF THE SEVERAL VIEWS OF THE DRAWINGS

Additional features of the invention will be clarified by the detailed description below, which refers to a merely illustrative, not limiting, embodiment, illustrated in the attached drawings, wherein:

FIG. 1 is a axial section showing a sealing assembly for mixer according to the prior art;

FIG. 2 is a view of the improved seal assembly of the invention sectioned with a plane passing through the axis of rotation of the mixer shaft whereon said improved assembly is applied; and

FIG. 3 is a view as FIG. 2 wherein the washing liquid is colored in grey and the working fluid is evidences in dots.

### DETAILED DESCRIPTION OF THE INVENTION

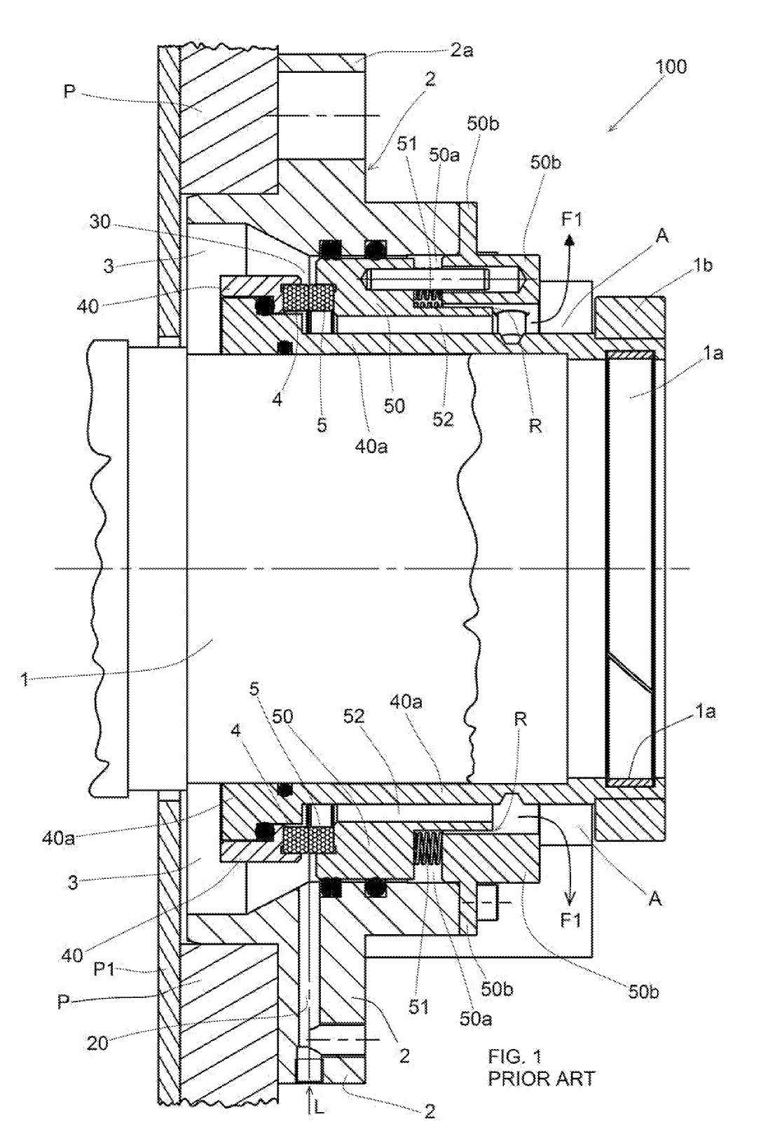

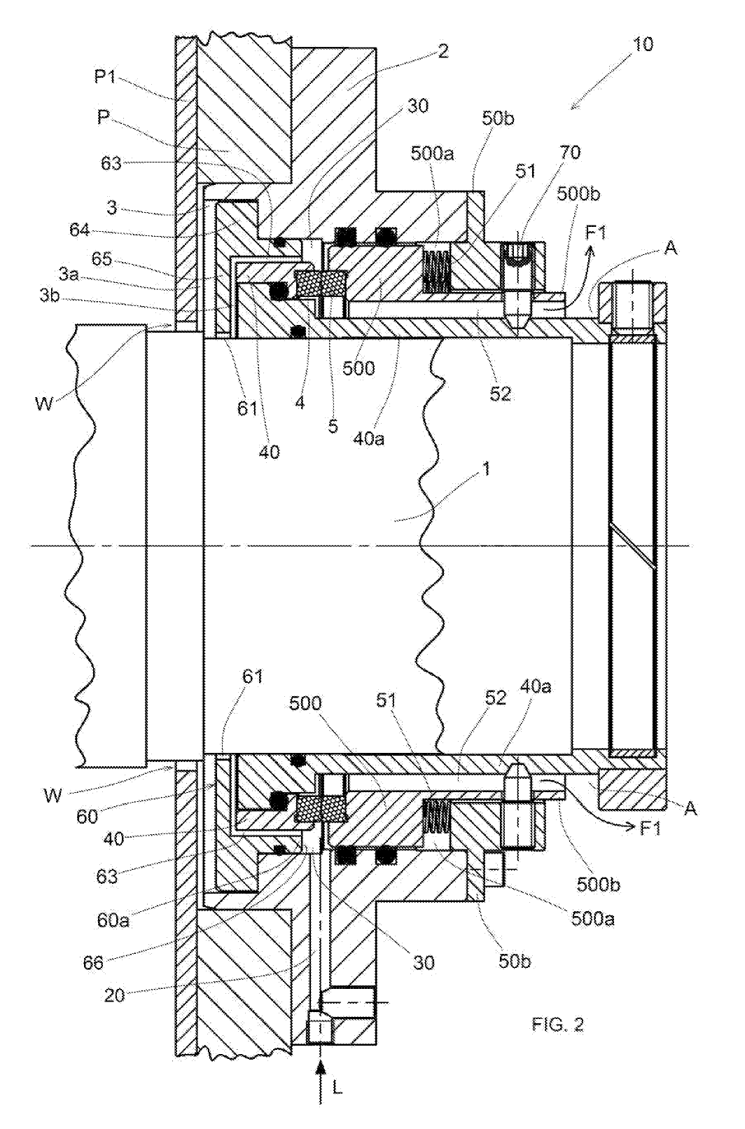

In FIG. 2 the elements that are identical to the elements described with reference to FIG. 1 are identified with the same identification number an the detailed description of the components of the improved seal assembly (10) that are identical to the components of the standard seal assembly (100) described with reference to FIG. 1 is omitted.

The improved seal assembly (10) comprises:
an empty body (2) to be inserted on the shaft (1) of a mixer or pump and secured to the fixed chassis (P) of said mixer or pump,
a first frictional seal ring (4) revolving together with said shaft (1);
a second non-revolving frictional seal ring (5) coupled with said empty body (2) and disposed in such manner to be interfaced and pressed against said first frictional seal ring (4) to generate a seal against the fluid processed by said mixer or pump;
an inlet channel (3) obtained in said body (2) and ending with an end chamber (30) that surrounds the pair of seal rings (4,5); and
one or more channels (20) for the introduction of a washing liquid (L) obtained inside said empty body (2) and ending into said end chamber (30).

The inlet channel (3) serves for input of a working fluid (W) coming from the mixer tank.

The improved seal assembly (10) is characterized in that it also comprises a flange (60) secured to said empty body (2) and housed inside said inlet channel (3) of the empty body.

Said flange (60) is provided with a peripheral collar (60a) facing towards said annular chamber (30) and coaxial with the shaft (1). Said peripheral collar (60a) externally adheres to the empty body (2). The peripheral collar (60a) internally surrounds said first support collar (40) of the first seal ring (4). A first annular gap (63) is generated between said peripheral collar (60a) and said first collar (40).

The flange (60) comprises a collar (64) secured to the empty body (2) and an obstruction disk (65) radially protruding internally from the collar (64). In this manner the obstruction disk (65) subdivides the input cannel (3) of the empty body into a first chamber (3a) facing forward the mixer tank and a second chamber (3b) facing forward the sealing ring (3, 4). The second chamber (3b) is communicating with the end chamber (30) surrounding the sealing ring (3, 4). The obstruction disk (64) of the flange has a central hole housing, with clearance, the shaft (1). In this manner, a second gap (61) is formed between the shaft (1) and the obstruction disk (25) of the flange. The second gap (61) is thin gap in order to allow the washing liquid to pass and in order to obstruct the passage of the working fluid (W). The width of the second chamber (3b) is thin and substantially similar to the width of the second gap (61).

The second gap (3b) communicates with the first annular gap (63). It is to be noted that the second chamber (3b) and the first annular gap (63) generate a “L” shaped path.

The washing liquid (L) from the end chamber (30) flows into the first annular gap (63), into the second chamber (3b), into the second gap (61) and into the first chamber (3a) in order to fall into the mixer tank. In this manner, the washing liquid is forced to follow a labyrinth path, in order to flow from the end chamber (30) to the first chamber (3a) of the empty body. Said labyrinth path not only promotes the permanence and stagnation washing liquid (L) into the end chamber (30), but also it prevents that the working fluid (W) penetrates into the end chamber (30) or goes near the rotating supports (40, 4aa) supporting the first seal ring (4).

The peripheral collar (60a) comprised an edge (66) disposed in front of the end chamber (30). The edge (66) of the peripheral collar generates a first overflow for the washing liquid (L) poured inside said end chamber (30) from the feed channel (20). The second gap (61) generates a second overflow for the washing liquid (L) from the second chamber (3b) towards the first chamber (3a). Said overflows favor the stagnation of the washing liquid (L) in the end chamber (30); said stagnation of the washing liquid (L) is very important and useful when the shaft (1) is still, in order to hinder the free flow and the stagnation of the working fluid (W) processed by the mixer in the proximity of the pair of seal rings (4, 5).

The first overflow creates a barrier that prevents the washing liquid (L) from being poured into the mixer tank as soon as the end chamber (30) is flooded, forcing the washing liquid (L) to extend its course along a centripetal direction, before entering the first annular gap (63) and being discharged into the mixer tank.

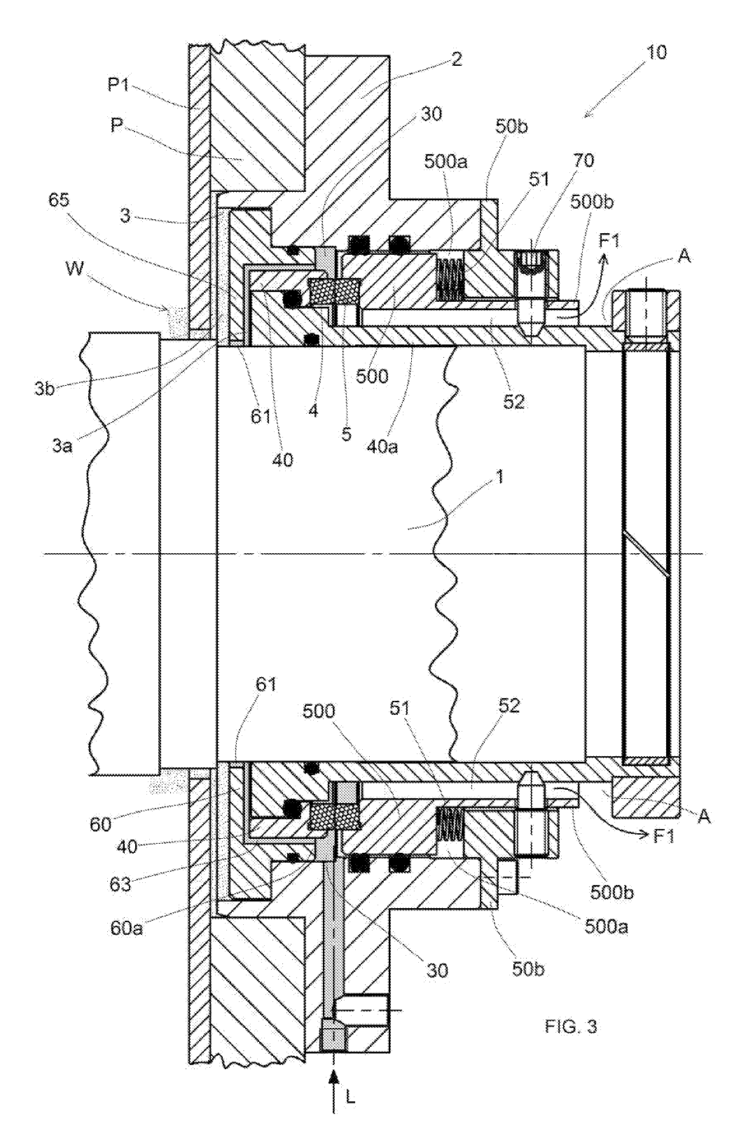

As showed in FIG. 3, the washing liquid (L) (evidenced in gray) remains into the end chamber (30), into the first gap (63) and into the second chamber (3a). On the contrary the working fluid (W) (evidenced in dots) remains into the first chamber (3b).

The first ring (4) revolves because it is joined to the revolving shaft (1) by means of a first support collar (40) mounted outside a short tube (40a) tightened around the shaft (1).

The second ring (5) is supported by a second support collar (500) slidingly coupled to the empty body (2) along a direction parallel to the axis of rotation of the shaft (1).

A plurality of springs (51) push the support collar (500) in a translation towards the first ring (4) in such manner to keep the interfaced frictional surfaces of the rings (4, 5) always in close contact. The springs (51) are disposed inside housings (500a) obtained in said second support collar (500). The housings (500a) are closed by a counter flange (50b) in order to preload the springs (51). The counter flange (50b) Is secured to said tube (40a) by means of radial pins (70). The second collar (500) is provided with a circular collar (500b). Said housings (500a) and said counter flange (50b) are situated outside the circular collar (500b). The collar (500b) ends in the drain area (A) for draining toward outside any fluid leaks that accidentally occur between the interfaced frictional surfaces of the pair of seal rings (4, 5).

Said accidental leaks from the pair of seal rings (4, 5) axially pass through an annular gap (52) between the tube (40a) and the second collar (500). The annular gap (52) extends in axial direction from the pair of the seal rings (4, 5) to the drain area (A). Said annular gap (52) prevents said leaks from being poured out inside the housings (500a) of the springs (51), thus damaging elasticity of the springs (51).

1. Seal assembly for front mechanical seal for pumps and fluid mixers having a tank wherein a working fluid is processed and a rotating shaft, the seal assembly comprising:
an empty body to be inserted on the shaft of the mixer or pump and secured to the fixed chassis of said mixer or pump,
a first frictional seal ring revolving together with said shaft;
a second non-revolving frictional seal ring coupled with said empty body and disposed in such manner to be interfaced and pressed against said first frictional seal ring to generate seal against the working fluid processed by said mixer or pump;
an inlet channel obtained in said empty body and ending with an end chamber that surrounds the pair of seal rings;
one or more channels for the introduction of a washing liquid obtained inside said empty body and ending into said end chamber (30); and
a flange secured to said empty body coaxial to the shaft, housed inside said inlet channel and shaped in such manner to generate at least one overflow that favors stagnation of washing liquid inside said end chamber that surrounds the pair of seal rings and prevent the inflow of said working fluid in said end chamber.

2. The seal assembly of claim 1, wherein said flange comprises a peripheral collar facing towards said end chamber and generates a first annular gap between supports of the first seal ring and said peripheral collar.

3. The seal assembly of claim 2, wherein said peripheral collar has an edge situated in front of the end chamber, in order to generate a first overflow for the washing liquid poured inside said end chamber from the feed channel, allowing the washing liquid to stagnate into the end chamber.

4. The seal assembly of claim 1, wherein said flange comprises an obstruction disk extending radially inwardly, in order to generate a first chamber facing forward the tank and a second chamber facing forward said seal rings.

5. The seal assembly of claim 4, wherein said obstruction disk has a central hole wherein said shaft is housed, with clearance, so as to generate a second gap between said shaft and said second gap defining a second overflow, in order to prevent the working fluid to pass from the first chamber to the second chamber.

6. The seal assembly of claim 1, comprising:
a tube tightened around the shaft and a first support collar fixed to said tube and supporting said first ring;
a second support collar supporting said second ring and coupled to the empty body slidingly along a direction parallel to the axis of rotation of the shaft;
a plurality of springs disposed inside housings obtained in said second support collar, said springs pushing the support collar in a translation towards the first ring in such manner to keep the interfaced frictional surfaces of the rings always in close contact;
an annular gap between the pipe and the second support collar that extends axially from the pair of seal rings until a drain area for liquid leaks, so that the liquid leaks does not go into said housing of the springs and the liquid leaks flow externally

7. The seal assembly of claim 6, wherein said second support collar comprises:
a circular collar comprising said housing for the springs; and
a counter-flange fixed to the empty body and disposed in the housings of the spring to preload the springs.
